(19) United States
(12) Patent Application Publication
(10) Pub. No.: US 2009/0034182 A1
(43) Pub. Date: Feb. 5, 2009

(54) PORTABLE ELECTRONIC DEVICE

(75) Inventors: Yi-Cheng Shiu, Taipei (TW); Ching-Sung Yeh, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., TAIPEI CITY (TW)

(21) Appl. No.: 12/182,007

(22) Filed: Jul. 29, 2008

(30) Foreign Application Priority Data
Aug. 2, 2007 (TW) TW96128381

(51) Int. Cl. G06F 1/16

(52) U.S. Cl. 361/683

(57) ABSTRACT

A portable electronic device includes a main body and a dummy adapter. The main body includes an adapter slot. The dummy adapter is detachably disposed in the adapter slot, and it includes an accommodating space for accommodating an information medium.

### CROSS REFERENCE TO RELATED APPLICATIONS

This application claims priority of Taiwan Patent Application No. 96128381, filed on Aug. 2, 2007, the entirety of which is incorporated by reference herein.

### BACKGROUND OF THE INVENTION

1. Field of the Invention

The invention relates to a portable electronic device and, more particularly, to a portable electronic device with a dummy adapter.

2. Description of the Related Art

Generally speaking, with the progress of the science and technology, applying new technology to the notebook computer is an unavoidable trend. However, application of the new technology is limited by the limited space and esthetics of appearance of the notebook computer, which is obvious for the light and slim notebook computer.

### BRIEF SUMMARY OF THE INVENTION

One objective of the invention is to provide a portable electronic device which is capable of accommodating additional information media without increasing the volume thereof to effectively use the existing room.

The portable electronic device of the invention includes a main body and a dummy adapter. The main body has an adapter slot, and the dummy adapter is detachably disposed in the adapter slot and has an accommodating space for accommodating an information medium.

In one embodiment of the invention, the shape of the dummy adapter corresponds to that of the adapter slot.

In one embodiment of the invention, the shape of the accommodating space corresponds to that of a memory card.

In one embodiment of the invention, the shape of the accommodating space corresponds to that of a touch pen.

In one embodiment of the invention, the dummy adapter further has a sidewall and an opening formed at the sidewall and communicating with the accommodating space, and the information medium is accommodated in the accommodating space via the opening.

In one embodiment of the invention, the information medium includes a memory card.

In one embodiment of the invention, the information medium includes a touch pen.

These and other features, aspects, and advantages of the present invention will become better understood with regard to the following description, appended claims, and accompanying drawings.

### BRIEF DESCRIPTION OF THE DRAWINGS

FIG. 1A is a three-dimensional exploded diagram showing the portable electronic device according to one embodiment of the invention;

FIG. 1B is a three-dimensional assembly diagram showing portable electronic device according to one embodiment of the invention;

FIG. 2A is a three-dimensional exploded diagram showing the dummy adapter and the information media of the portable electronic device according to the embodiment of the invention; and

FIG. 2B is a three dimensional assembly diagram showing the dummy adapter and the information media of the portable electronic device according to one embodiment of the invention.

### DETAILED DESCRIPTION OF THE EMBODIMENTS

The preferred embodiment of the invention is described with the appended drawings.

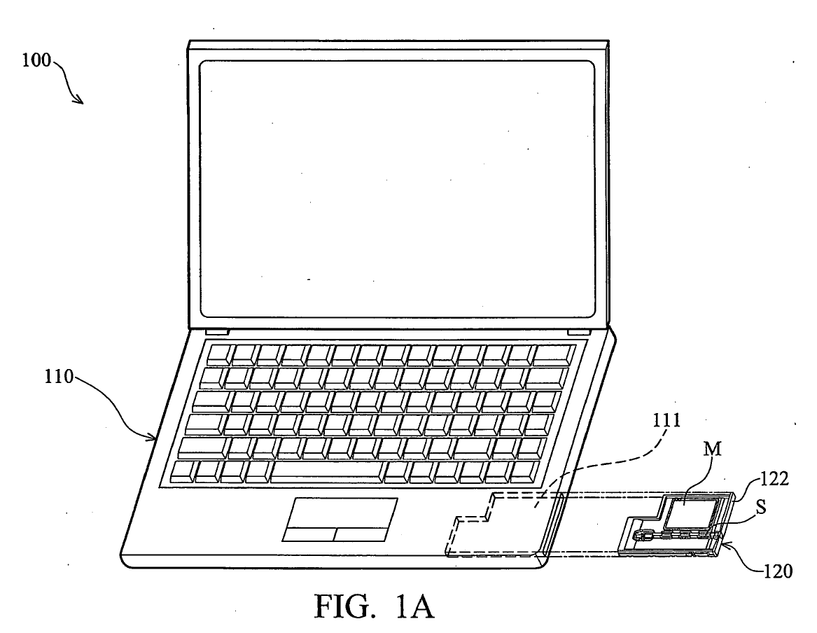

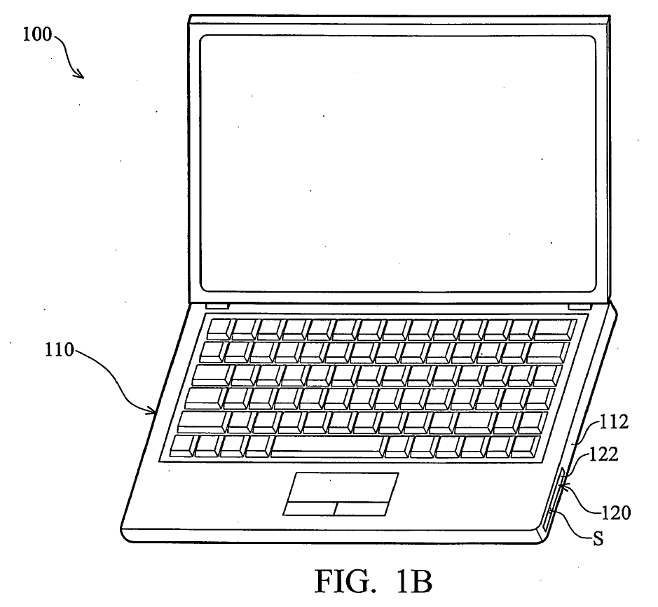

As shown FIG. 1A and FIG. 1B, the portable electronic device 100 of the embodiment is, for example, a notebook computer, and it mainly includes a main body 110 and a dummy adapter 120.

As shown in FIG. 1A, the main body 110 has an adapter slot 111. Herein, an adapter (such as an express card which is not shown) may be selectively disposed in the adapter slot 111 and electrically connected to the main body 110.

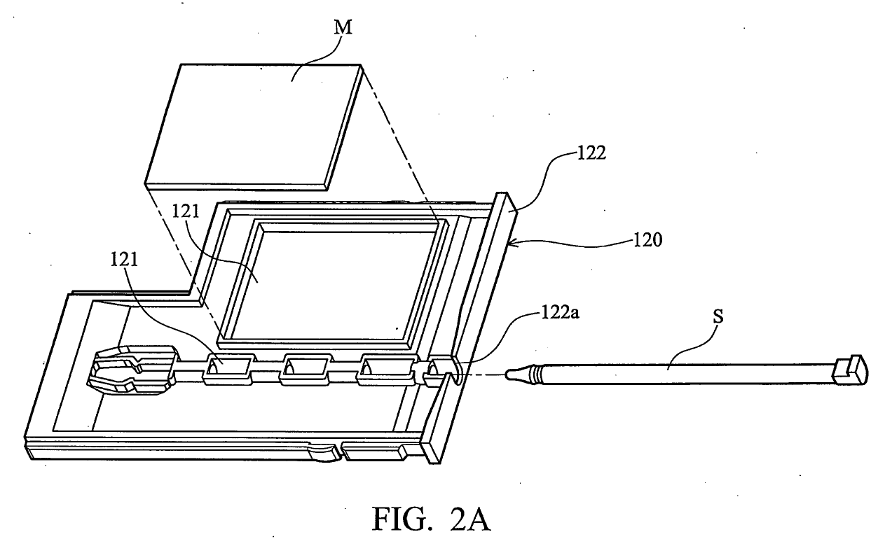

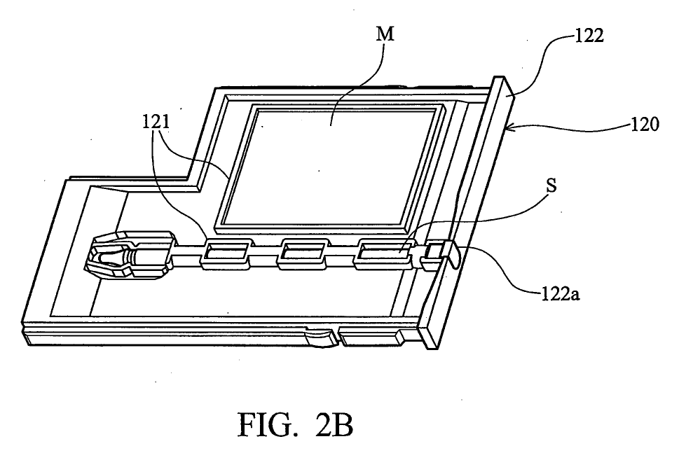

As shown in FIG. 1A and FIG. 2A, the dummy adapter 120 is detachably disposed in the adapter slot 111, and it has a plurality of accommodating spaces 121 (as shown in FIG. 2A). The accommodating spaces 121 are used to accommodate a plurality of information media (such as a memory card of a digital camera or a mobile phone and a touch pen). The shape of the dummy adapter 120 corresponds to that of the adapter slot 111. Thus, the dummy adapter 120 may be positioned in the adapter slot 111. In the embodiment, the dummy adapter 120 has, for example, two accommodating spaces 121 having shapes corresponding to the shapes of a memory card M and a touch pen S, respectively. The dummy adapter is not limited to have accommodating spaces 121, and it also may have more accommodating spaces 121 according to the actual need to accommodate more information media.

When the memory card M and the touch pen S are not used, they are placed in the two accommodating spaces 121 of the dummy adapter 120, respectively, as shown in FIG. 2B. Then, the dummy adapter 120 having the memory card M and the touch pen S is inserted into the adapter slot 111 of the main body 110. Thus, the memory card M and the touch pen S are accommodated.

In addition, in the embodiment, the touch pen S may be extracted when the dummy adapter 120 is located in the adapter slot 111. In detail, as shown in FIG. 2A and FIG. 2B, the dummy adapter 120 also has a sidewall 122 and an opening 122a formed on the sidewall 122. The opening 122a communicates with the accommodating space 121 for accommodating the touch pen S. As shown in FIG. 1B, when the dummy adapter 120 is located in the main body 110 (or the adapter slot 111), the sidewall 122 of the dummy adapter 120 is level with a lateral surface 112 of the main body 110. The touch pen S may be extracted to be used from the dummy adapter 120 via the opening 122a or be inserted to the dummy adapter 120 via the opening 122a.

As stated above, the information medium such as the memory card M and the touch pen S may be accommodated in the existing room (namely the adapter slot 111) of the portable electronic device (notebook computer) 100 when it is not used. Therefore, additional accommodating room does not need to add to the portable electronic device (notebook computer) 100, and appearance of the portable electronic device 100 does not need to be changed. Thus, the portable electronic device may be kept light and slim.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable electronic device comprising:
a main body having an adapter slot; and
a dummy adapter detachably disposed in the adapter slot and having an accommodating space for accommodating an information medium.

2. The portable electronic device according to claim 1, wherein the shape of the dummy adapter corresponds to the shape of the adapter slot.

3. The portable electronic device according to claim 1, wherein the shape of the accommodating space corresponds to the shape of a memory card.

4. The portable electronic device according to claim 1, wherein the shape of the accommodating space corresponds to the shape of a touch pen.

5. The portable electronic device according to claim 1, wherein the dummy adapter further has a sidewall and an opening formed at the sidewall and communicating with the accommodating space, and the information medium is accommodated in the accommodating space via the opening.

6. The portable electronic device according to claim 1, wherein the information medium comprises a memory card.

7. The portable electronic device according to claim 1, wherein the information medium comprises a touch pen.
